(19) United States
(12) Patent Application Publication
(10) Pub. No.: US 2007/0235031 A1
(43) Pub. Date: Oct. 11, 2007

(54) FULL FACE RESPIRATORY PROTECTION DEVICE

(75) Inventor: James R. Betz, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/278,277

(22) Filed: Mar. 31, 2006

(51) Int. Cl. A62B 18/02; A62B 18/08

(52) U.S. Cl. 128/206.21; 128/207.11

(57) ABSTRACT

A full face respiratory protection device that comprises a face seal; one or more parts for supplying clean air to the interior gas space; a harness for supporting the mask on a wearer's face; and a lens that is coupled to the face seal and that assists in establishing an effective field of view greater than 95% and a peripheral field of view greater than 60%.

### BACKGROUND

Respiratory protection devices (also referred to as respirators) for providing a breathable air supply to a wearer are used in a variety of different applications. The respirators can be used during fires, military operations, and hazardous industrial applications where the air supply may be contaminated. In addition to providing a clean air source to the nose and mouth for breathing, full-face respirators also protect the eyes and face from harmful or irritating gases and other substances. The devices can further include mounts for accepting detachable and replaceable filter elements or connectors to air supplies.

There are a number of specific types of respirators in common use. Known full face respirators include a lens, a face seal for mounting the lens about the face of a wearer, and one or more ports for providing an air supply to the wearer's face. Many of the components of the respirator can inhibit the field of vision for the wearer, which can be problematic to the wearer during operation.

### SUMMARY OF THE INVENTION

This summary is not intended to describe each disclosing embodiment or every implementation of the concepts presented herein. The figures and the description that follows more particularly exemplify illustrative embodiments.

The present invention provides a full face respiratory protection device that comprises a face seal; one or more parts for supplying clean air to the interior gas space; a harness for supporting the mask on a wearer's face; and a lens that is coupled to the face seal and that assists in establishing an effective field of view greater than 95% and a peripheral field of view greater than 60%.

### GLOSSARY

The terms set-forth below will have meaning as defined:

“clean air” means a volume of air or oxygen that has been filtered to remove contaminants or that otherwise has been made safe to breath.

“contaminants” means particles and/or other substances that generally may not be considered to be particles (e.g., organic vapors, et cetera) but may be suspended in air.

“effective field of view” (EFV) means a percentage value of light reaching a spherical surface for the test as described in European Standards Organisations, Standard Number I.S. EN 136 RESPIRATORY PROTECTIVE DEVICES—FULL-FACE MASKS—REQUIREMENTS, TESTING, MARKING; Version 1998, Part 7.21 Field of Vision.

“exhaled air” is air that is exhaled by a face mask wearer.

“exterior gas space” means the ambient atmospheric gas space into which exhaled gas ultimately enters after passing through and beyond the full mask respiratory mask.

“full face respiratory protection device” means a device that fits over the nose, mouth, and eyes of a person for purposes of supplying clean air to the wearer.

“inhale filter element” means a fluid-permeable structure through which air passes before being inhaled by a wearer so that contaminants and/or particles can be removed therefrom.

“inhalation valve” means a valve that opens to allow a fluid to enter a face mask's interior gas space.

“interior gas space” means the space between the respiratory mask and a person's face.

“lens” means a device made of a material that allows light to pass therethrough.

“mask body” means a structure that can fit at least over the nose, mouth, and eyes of a person and that helps define an interior gas space separated from an exterior gas space.

“peripheral field of view” (PFV) means a percentage value of light reaching a spherical surface between longitude lines 60 and 120 and latitude lines 90 and 110 on each side of a test head for the test as described in European Standards Organisations, Standard Number I.S. EN 136 RESPIRATORY PROTECTIVE DEVICES—FULL-FACE MASKS—REQUIREMENTS, TESTING, MARKING; Version 1998, Part 7.21 Field of Vision.

### BRIEF DESCRIPTION OF THE DRAWINGS

The concepts presented herein will be further explained with reference to the attached figures, wherein like structure or system elements can be referred to by like reference numerals throughout the several views.

FIG. 1 is an isometric view of a respiratory protection device 10 being worn by a wearer.

FIG. 2 is an exploded isometric view of a respiratory protection device 10.

FIG. 3 is a schematic side view of a test head 70 and a spherical surface 72.

FIG. 4 is a schematic back view of a test head 70 and a spherical surface 72.

FIG. 5 is a schematic side view of a test head 70 and a spherical surface 72 illustrating a peripheral field of view zone 80.

FIG. 6 is a schematic back view of a test head 70 and a spherical surface 72 illustrating two peripheral field of view zones 80, 82.

While the above-identified figures set forth one or more embodiments of the present invention, other embodiments are also contemplated, as noted herein. In all cases, concepts presented herein describe the invention by way of representation and not by limitation. Other modifications and embodiments can be devised by those skilled in the art, which fall within the scope and spirit of the principles of this invention.

### Detailed Description of the Preferred Embodiments

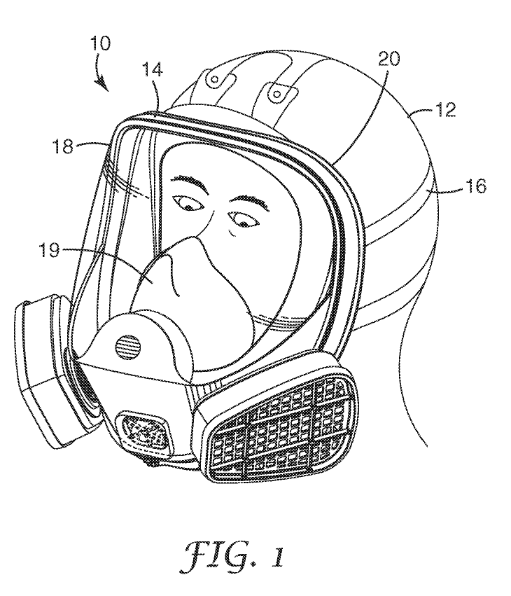

FIG. 1 is an isometric view of a full face respiratory protection device 10 that includes a face seal 14 and a harness 16 for securing the device 10 to a head 12 of the wearer. A unitary body 18 forms an interface with face seal 14 to prevent exterior air and contaminants from reaching a wearer's face. A nose cup 19 is coupled to unitary body 18 and surrounds a nose and mouth of wearer 12. A frame 20 is provided to clamp unitary body 18 to face seal 14. During operation, device 10 protects wearer 12 from harmful gases, vapors and/or particulate matter. At least one port including an inhalation valve is provided in unitary body 18 to provide a connection for an air inlet and/or outlet. In some instances, a separate inhalation port and a separate exhalation port are employed.

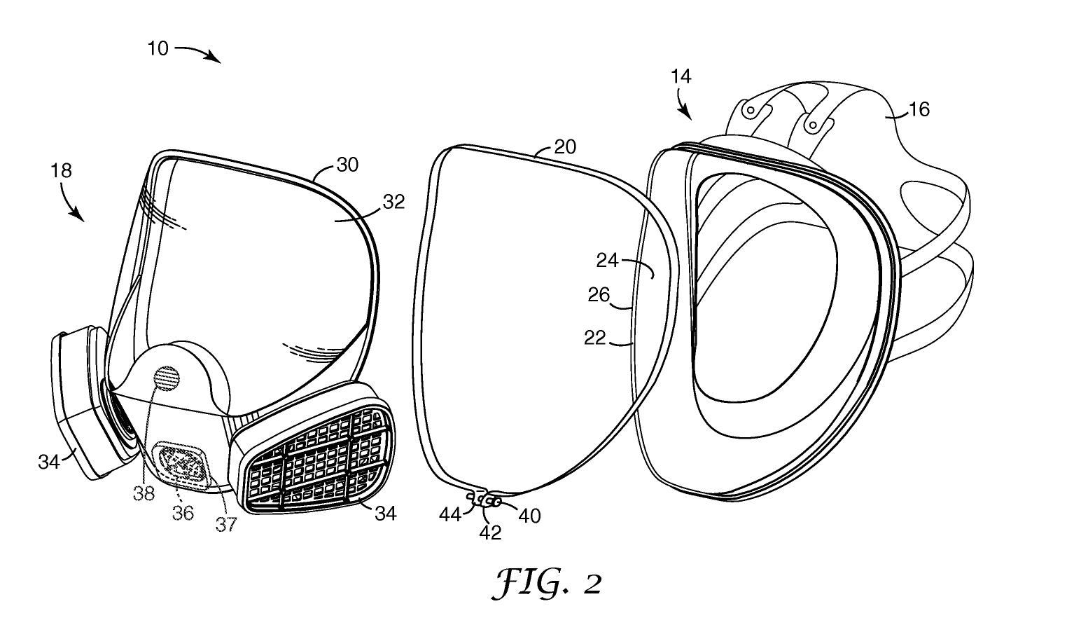

FIG. 2 is an exploded isometric view of device 10. Face seal 14 is designed to provide a fluid-tight seal with the face of the wearer as well as interface with various unitary body constructions such as unitary body 18. Together, face seal 14 and unitary body 18 form a mask body that defines a boundary between exterior gas space and the wearer's interior gas space. Unitary body 18 can support and carry various functional components for device 10. For example, a wearer can choose a particular unitary body that includes a speaking port and/or connection to a powered air supply depending on a situation in which device 10 is used.

In order to form an interface with unitary body 18, face seal 14 includes an annular ring 22. Annular ring 22 can be made of an elastomeric rubber such as silicone rubber and sized to surround a face of a wearer so as to not significantly inhibit a field of view of the wearer. Unitary body 18 forms an interface with an inner surface 24 of annular ring 22. Frame 20 surrounds an outer surface 26 of annular ring 22 to provide a clamp to seal inner surface 24 against unitary body 18.

Unitary body 18 includes a chassis 30 and a lens 32 integral with chassis 30. Chassis 30 forms a support structure for functional components in respiratory device 10. These functional components can include one or more lenses, breathing components, speaking components, sensors, etc. In the embodiment illustrated, chassis 30 supports lens 32, side cartridges 34, an exhaust port 36 and a speaking port 38. In other embodiments, unitary body 18 need not include a separate chassis and lens, but rather be an integral piece with a similar configuration to body 18.

Chassis 30 can be formed from a thermoplastic material that is resistant to high temperatures and chemical agents. For example, chassis 30 can be formed of an engineering-grade thermoplastic such as nylon, Xenoy® resin and/or combinations thereof. Xenoy® resin is a blend of semi-crystalline polyester (which can for example be polybutylene terephthalate (PBT) or polyethylene terephthalate (PET)) and polycarbonate. Xenoy® resin is available from GE Plastics of Pittsfield, Mass. If desired, chassis 30 can be opaque to prevent passage of light therethrough. The chassis may include other physical properties as desired, such as being resistant to abrasives, impact and/or welding spatter, for example.

Lens 32 can be formed of a transparent engineering-grade thermoplastic such as polycarbonate and affixed to chassis 30. Thus, chassis 30 and lens 32 can be formed of similar or different materials. Lens 32 can be bonded to chassis 30 to form an integral construction. For example, lens 32 can be chemically, mechanically, or thermally bonded to chassis 30. Lens 32 can be molded or otherwise formed and affixed to chassis 30 using a molding or welding process, for example. Alternatively, the lens and chassis could be made at the same time. In any event, a fluid-tight seal is formed between chassis 30 and lens 32. Additionally, the whole lens 32 can be transparent and can be treated with a coating to increase resistance to chemicals and/or scratching. As shown, the unitary body 18 includes the lens portion and the portion that contains the fluid communication/attachment components.

For different applications, lens 32 can be of various types, for example tinted, clear, polarized, auto darkening, etc. Since chassis 30 includes functional components of device 10, lens 32 need not include these components, which can reduce the amount of material used for lens 32 and the complexity of lens 32. Thus, the design of unitary body 18 and the overall configuration of device 10 can concentrate on optical characteristics that are important for the viewing area without compromising these characteristics due to the complexity needed in supporting other components. For example, structural geometry and/or other elements that can interfere with the field of view of the wearer can be reduced and/or removed. However, a proper fit and seal between seal 14 and a face of the wearer 12 should be maintained to provide adequate protection in hazardous situations without adding additional profile and/or weight to device 10. Lens 32 can have a cylindrical cross section that can extend behind the eyes of the wearer when viewing an appropriate wearer of the respiratory protection device from a side profile. To that end, face seal 14 as well as frame 20 can extend behind the eyes to establish an EFV and PFV as discussed below. Further, face seal 14 can extend below the chin of an appropriate wearer 12. An “appropriate wearer” is a person who has a head sized to be properly fitted to the mask. In one example, the lens 32 is cylindrical about an upright axis with respect to wearer 12. In one embodiment, the axis is in the range ±30° from vertical. In another embodiment, the axis is in the range of 0-30° from vertical. In a further embodiment, the axis is in the range of 20-30° from vertical. Also, a bottom portion of chassis 30 can be obliquely oriented to lens 32 to prevent interference of cartridges 34 and/or other components with the wearer's field of view.

Side cartridges 34 can include suitable air treatment media including an inhale filter element such that a wearer will breathe ambient air from outside device 10, which is then filtered by the air treatment media or otherwise be made safe to breathe and/or be in contact with skin. Alternatively, an air supply hose can be attached to the fluid intake component to deliver clean air to the wearer. Cartridges 34 can be removable to allow other cartridges to be attached to chassis 30. Once wearer 12 breathes the clean air, the air can be exhausted as exhaled air through the exhaust port 36. A valve cover 37 is provided to cover port 36 to prevent unwanted entry of contaminants through port 36. Speaking port 38 can amplify or otherwise transmit sound from the wearer outside of device 10.

To seal unitary body 18 to face seal 14, unitary body 18 is placed into contact with inner edge 24 of annular ring 22. Unitary body 18 can include a channel having a rib to provide a more secure seal for the interface between face seal 14 and unitary body 18. Frame 20, which can be a locking band or collar, is then positioned around outer edge 26 of annular ring 22. Frame 20 is just one example of a mechanism that can be used to clamp face seal 14 to unitary body 18. Other suitable mechanisms can also be employed. In the embodiment illustrated, a fastener 40 can be used to provide a clamping force around outer surface 26 such that a sealed interface is formed between face seal 14 and unitary body 18. Frame 20 includes a first aperture 42 and a second aperture 44 to receive fastener 40. Second aperture 44 can be threaded to mate with threads on fastener 40.

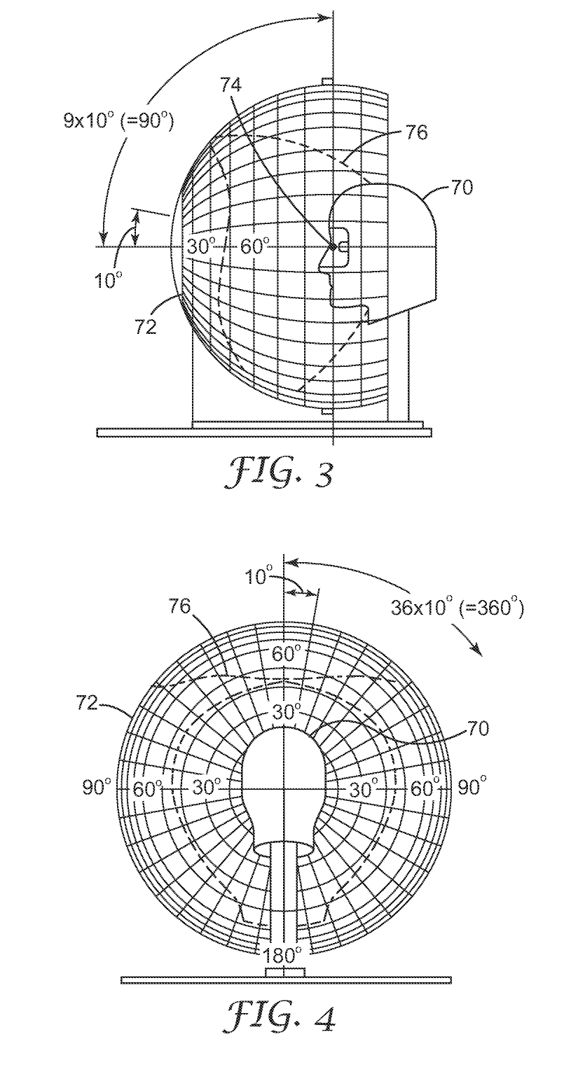

Respiratory device 10 is configured to establish an EFV greater than 95% and a PFV greater than 60%. This is achieved by appropriate selection of lens shape, fluid intake and exhaust locations, and face seal adaptation. Respiratory device 10 was evaluated without side cartridges 34. Thus, face seal 14, harness 16, unitary body 18 and frame 20 were used, which will hereafter be referred to as a mask. Unitary body included a transparent chassis 30 and transparent lens 32. The mask was evaluated by the test method described in European Standards Organisations, Standard Number I.S. EN 136 RESPIRATORY PROTECTIVE DEVICES—FULL-FACE MASKS—REQUIREMENTS, TESTING, MARKING; Version 1998, Part 7.21 Field of vision. FIGS. 3-4 illustrate a test head 70 and a spherical surface 72. With this test, the mask was mounted on a test head with light sources 74 placed at eye locations. Projection of light through the mask, onto a translucent spherical surface 72 marked with lines of longitude and latitude, was measured to model the range of sight possible through the mask. The standard specifies a perimeter of projection 76, the inner bounds of which is defined to be the EFV. A mask with light projection that would cover the entire EFV would be considered to have a 100% EFV, where a mask with a projection covering only 0.9 of the EFV area would have a 90% EFV.

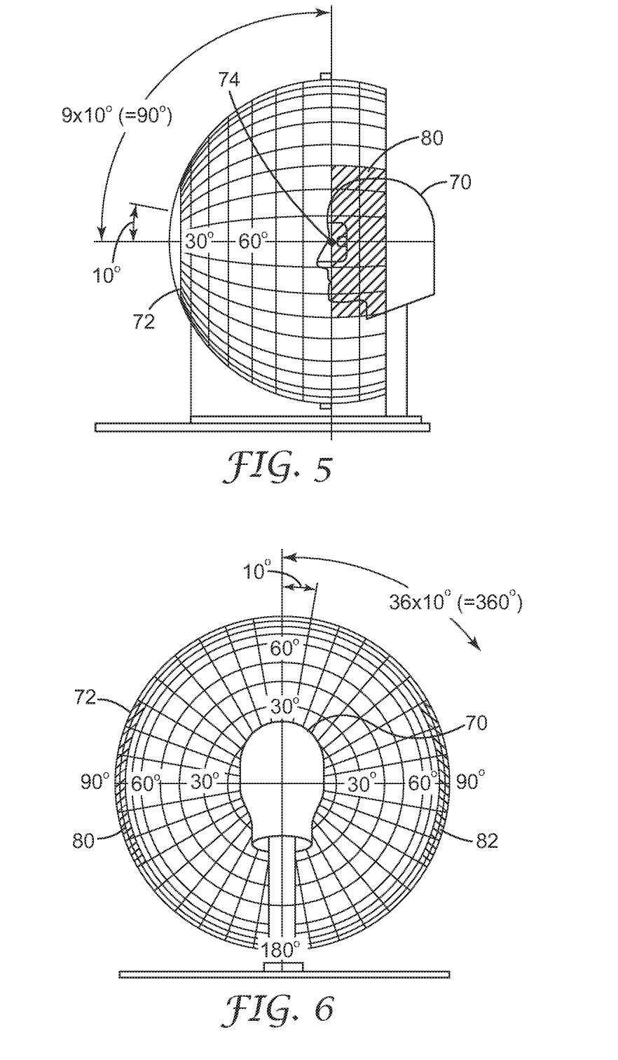

In addition to EFV, a PFV was measured. FIGS. 5-6 illustrate peripheral field of view zones 80 and 82. PFV was established as the spherical surface between longitude lines 60 and 120 and latitude lines 90 and 110 on one side of the test head and between longitude lines 60 and 120 and latitude lines 90 and 110 on an opposite side of the test head. This space defines projections representative of the side or peripheral view of a wearer of a mask.

The mask tested using the EFV and PFV test methods. Additionally, other masks that are commercially available were tested. Results of the tests are given in Table 1 below. The masks were evaluated with a nose cup affixed but with no cartridges attached.

Example 1 is the mask associated with respiratory device 10 described above. Examples of commercially available full-face respirator masks include Scott AV 2000 (Example 2) and Sabre protector (Example 3) from Scott Health Safety of Monroe, N.C.; ISI (Example 4) from ISI of Lawrenceville, Ga.; 3M 6800 (Example 5) from 3M Corporation of St. Paul, Minn.; and North 7600 (Example 6) from North Safety Products of Cranston, R.I.

TABLE 1

| | | Effective Field | Peripheral Field |
|---|---|---|---|
| Example | Mask | of View (EFV) | of View (PFV) |
| 1 | Device 10 | 99% | 81% |
| 2 | Scott AV-2000 | 85% | 53% |
| 3 | Sabre Protector | 97% | 57% |
| 4 | ISI | 91% | 31% |
| 5 | 3M 6800 | 92% | 59% |
| 6 | North 7600 | 91% | 95% |

As is evident by the Field of View data given in Table 1, only the mask associated with device 10 has a combined EFV greater than 95% and a PFV greater than 60%. This combination of view factors gives the mask significantly improved viewing range over the other example masks.

Although the present invention has been described with reference to several alternative embodiments, workers skilled in the art will recognize that changes may be made in form and detail without departing from the spirit and the scope of the invention. Further, features shown and described with respect to one embodiment may be combined with features of other embodiments, as desired.

What is claimed is:

1. A full face respiratory protection device that comprises:
(a) a face seal;
(b) one or more parts for supplying clean air to the interior gas space;
(c) a harness for supporting the mask on a wearer's face; and
(d) a lens that is coupled to the face seal and that assists in establishing an effective field of view greater than 95% and a peripheral field of view greater than 60%.

2. The respiratory device of claim 1, wherein the peripheral field of view is greater than 70%.

3. The respiratory device of claim 1, wherein the peripheral field of view is greater than 80%.

4. The respiratory device of claim 1, wherein the effective field of view is greater than 98%.

5. The respiratory device of claim 1, wherein the effective field of view is greater than 99%.

6. The respiratory device of claim 1, wherein the effective field of view is greater 98% and the peripheral field of view is greater than 80%.

7. The respiratory device of claim 1, wherein the lens includes a cylindrical cross-section about a vertical axis.

8. The respiratory device of claim 1, wherein the harness is coupled to the face seal.

9. The respiratory device of claim 1, wherein the face seal extends behind eyes of the wearer when viewing the wearer's profile from the side.

10. The respiratory device of claim 1, wherein the lens extends behind the eyes of the wearer when viewing the wearer's profile from the side.
